(19) United States
(12) Patent Application Publication
(10) Pub. No.: US 2007/0226695 A1
(43) Pub. Date: Sep. 27, 2007

(54) Crawler based auditing framework

(75) Inventors: Muralidhar Krishnaprasad, Fremont, CA (US); Meeten Bhavsar, Emerald Hills, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/649,098

(22) Filed: Jan. 3, 2007

Related U.S. Application Data
(60) Provisional application No. 60/777,988, filed on Mar. 1, 2006.
(60) Provisional application No. 60/853,507, filed on Oct. 20, 2006.

(51) Int. Cl. G06F 9/44

(52) U.S. Cl. 717/126

(57) ABSTRACT

Systems, methods, and other embodiments associated with post-crawl auditing are described. One system embodiment includes an audit logic that can be controlled to apply an audit rule to crawl data. The crawl data may be acquired by a crawl logic that provides the crawl data to an index logic. The crawl logic may be configured to crawl documents stored in different locations in an enterprise. The crawl logic may also be configured to crawl documents having different formats. The index logic may be configured to create an index that supports searching for documents in the enterprise. The audit logic may process the crawl data independent of the operation of the index logic.

### CROSS REFERENCE TO RELATED APPLICATIONS

This application claims the benefit of U.S. Provisional Patent Application Ser. No. 60/777,988 filed Mar. 1, 2006, titled “Systems and Methods For Searching”. This application also claims the benefit of U.S. Provisional Patent Application Ser. No. 60/853,507 filed Oct. 20, 2006, titled “Crawler Based Auditing Framework”.

### BACKGROUND

An enterprise may have a variety of data having a variety of formats. This disparate data may be stored in a number of locations. For example, emails may be stored in email servers and on user desktop systems. Similarly, calendar information may be stored in a calendar server and on user desktop systems. Documents (e.g., word processing files, spreadsheets, presentations, web pages) may be stored in different locations distributed throughout the enterprise. Simply keeping track of all this data can be a daunting task. Auditing this data can be even more daunting.

Conventionally, when auditing was attempted, each system (e.g., email, calendar, word processing) may have implemented its own auditing system. These were typically stand alone systems that did not integrate auditing data or responsibilities and that did not act on any normalized data. Using this collection of auditing systems may have left security holes. Consider an enterprise having both a content management system and a website to which content may be posted. Consider further that the content management system may have an auditing system but that the website does not have an auditing system. Sensitive information could be posted to the website from the content management system without the enterprise becoming aware of the violation through any audit. This could leave an enterprise in violation of regulations (e.g., Sarbanes-Oxley) and/or internal policies concerning provably secured and audited data. Unfortunately, implementing auditing for widely disparate systems, including non-transactional systems, may be complex and costly, if possible at all.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

Prior Art FIG. 1 illustrates an enterprise search system.

FIG. 2 illustrates a portion of an example enterprise search system having post-crawl auditing functionality.

FIG. 3 illustrates an example enterprise search system having post-crawl auditing functionality.

FIG. 4 illustrates an example method associated with enabling post-crawl auditing.

FIG. 5 illustrates an example method associated with post-crawl auditing.

FIG. 6 illustrates an example computing environment in which example systems and methods illustrated herein may operate.

### DEFINITIONS

The following includes definitions of selected terms employed herein. The definitions include various examples and/or forms of components that fall within the scope of a term and that may be used for implementation. The examples are not intended to be limiting. Both singular and plural forms of terms may be within the definitions.

“ACE” as use herein, refers to an access control entry, which is a single directive to either grant or deny permission to an entity (e.g., user, group, owner).

“ACL”, as used herein, refers to an access control list. An ACL is a logical term that refers to a set of ACEs. An ACL may be represented in an XML (extensible markup language) format.

“Document”, as used herein, refers to an item of information. A document may by, for example, a file, a web page, an email, a spread sheet, and so on. A document is accessible to a crawler by a uniform resource locator (URL).

“Enterprise”, as used herein, refers to a set of computing resources belonging to an organization, where the organization may be a single entity and/or a formally defined collection of entities, and where the computing resources may include repositories of data and logic for processing data available in those repositories. An enterprise has identifiable boundaries and identifiable ownership.

“GUID”, as used herein, refers to a globally unique identifier, which is a string that uniquely represents a specific user or group of users in an LDAP (Lightweight Directory Access Protocol) directory.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Machine-readable medium”, as used herein, refers to a medium that participates in directly or indirectly providing signals, instructions and/or data that can be read by a machine (e.g., computer). A machine-readable medium may take forms, including, but not limited to, non-volatile media (e.g., optical disk, magnetic disk), and volatile media (e.g., semiconductor memory, dynamic memory). Common forms of machine-readable mediums include floppy disks, hard disks, magnetic tapes, RAM (Random Access Memory), ROM (Read Only Memory), CD-ROM (Compact Disk ROM), and so on.

“Logic”, as used herein, includes but is not limited to hardware, firmware, software and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on. In some examples, logic may be fully embodied as software. Where multiple logical logics are described, it may be possible in some examples to incorporate the multiple logical logics into one physical logic. Similarly, where a single logical logic is described, it may be possible in some examples to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, modules, methods, threads, and/or programs. In different examples software may be embodied in separate applications and/or code from dynamically linked libraries. In different examples, software may be implemented in executable and/or loadable forms including, but not limited to, a stand-alone program, an object, a function (local and/or remote), a servelet, an applet, instructions stored in a memory, part of an operating system, and so on. In different examples, computer-readable and/or executable instructions may be located in one logic and/or distributed between multiple communicating, co-operating, and/or parallel processing logics and thus may be loaded and/or executed in serial, parallel, massively parallel and other manners. Software, whether an entire system or a component of a system, may be embodied as an article of manufacture and maintained or provided as part of a machine-readable medium.

### DETAILED DESCRIPTION

Prior Art FIG. 1 illustrates an enterprise search system 100 that includes a crawling logic 110. Enterprise search system 100 may be, for example, Oracle Secure Enterprise Search (SES). Crawling logic 110 may search through an enterprise and retrieve content and/or metadata. Crawling logic 100 may facilitate populating an index 120. Index 120 may organize content, metadata, security information, and so on to support queries that search for documents and/or content. System 100 may also include a query logic 130 through which users can do enterprise wide searches and benefit from index 120. Rather than having to search the entire enterprise for each query from query logic 130, the system 100 can identify relevant results by interacting with index 120.

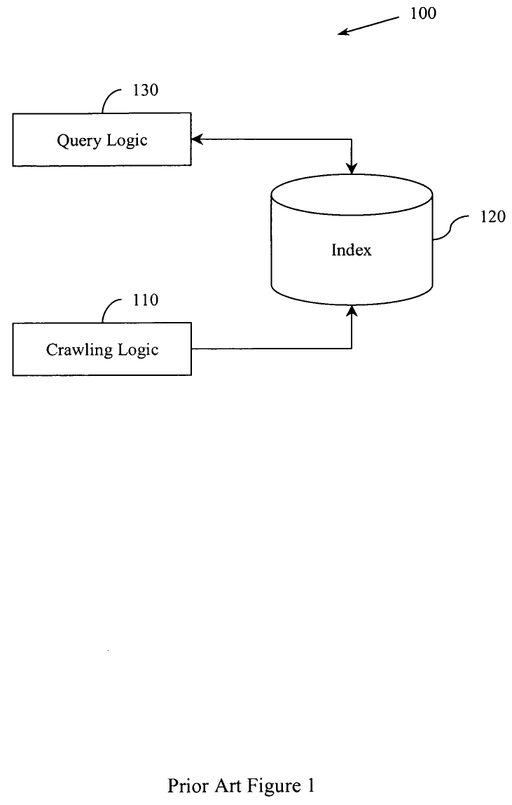

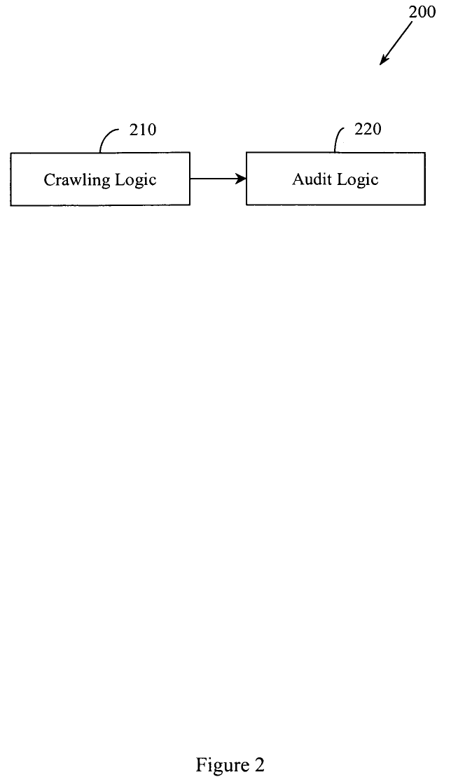

FIG. 2 illustrates a portion of an enterprise search system 200 that includes a crawling logic 210 similar to that described in association with FIG. 1. Thus, crawling logic 210 may be configured to access documents stored on different repositories belonging to an enterprise. The documents may have different document types, different security settings, and so on. The crawling logic 210 may interact with a set of document type specific crawlers that are able to crawl through data repositories in the enterprise and process documents having specific properties. Note that in some examples crawling logic 210 may not provide its output to an index. The output may be used for auditing.

Thus, FIG. 2 also illustrates an audit logic 220 that is operably connected to crawling logic 210. Audit logic 220 facilitates performing post-crawl auditing on crawl data provided by crawling logic 210. The crawl data may include, for example, content, metadata, and security information. The auditing may include, for example, applying rules and evaluating data with respect to auditing standards. Audit logic 220 may receive the crawl data in parallel with its delivery to other enterprise search system components (e.g., index logic, index). Crawling logic 210 can operate regardless of whether audit logic 220 is present and/or operating and regardless of whether an index logic is present and/or operating. Similarly, audit logic 220 may operate independent of either crawling logic 210 and/or an index logic.

Crawling logic 210 can detect whether a document or information associated with a document has changed since a previous crawl. For example, crawling logic 210 can identify changes to document content, document metadata, document location (e.g., repository) and document security information (e.g., ACL). Additionally, crawling logic 210 may identify changes to an ACL-ID, an owner GUID and so on. Crawling logic 210 may selectively mark a document for re-indexing if there has been a change. The indexing may include organizing content and accessible user information (e.g., security settings), which can then be used to support secure queries. Audit logic 220 may control crawling logic 210 to perform additional crawling based on audit logic 220 determinations.

A crawling system, which may include a set of crawlers, may touch (e.g., locate, examine, retrieve from) many sources. A crawler may retrieve data (e.g., content), metadata (e.g., title, type, creation date, modification date), and security information (e.g., access control entry (ACE), access control list (ACL)) associated with a document. This information may be normalized so that similar information concerning an email, a calendar entry, a web page, and so on, can be processed in a consistent and/or uniform manner. Normalized data may include, for example, a first paragraph of content, a keyword(s) extracted from content, author information, creation information, modification information, security information, and so on.

Information provided by a crawling system may be indexed, for example, by a search system to which the crawling system provides the information. Queries to locate relevant documents may thus interact with the index rather than trying to perform their own web search. The information provided by a crawling system may also be used to implement auditing services. In one example, auditing services may be added to a system that includes crawling infrastructure (e.g., crawlers, crawler APIs) and searching infrastructure (e.g., index, query processing).

In one example, auditing services may be applied to all data provided by a crawling system. In another example, auditing services may be selectively applied to data provided by a crawling system. The selective application may depend, for example, on rules applied to retrieved data by an auditing logic. These rules may identify data to audit based, for example, on data type, data ownership, data security settings, data history (e.g., forwarded email, updated blog), keywords found in data, and so on.

In one example, auditing logic 220 may employ rule indexes. A rule index may be, for example, a reverse index of rule words that can be accessed by each set of information provided by the crawling system. Using the rule index facilitates executing only relevant rules for sets of information provided by the crawling system. In one example, a rule index may include context rules associated with an index type (e.g., CTXRULE).

Operably connecting audit logic 220 to interact with a crawling system that provides normalized data to a search system facilitates centralizing auditing and facilitates coordinating auditing for different data sources, data types, and so on. Additionally, when the normalized data from a crawling system includes metadata (e.g., title, author) and/or security data (e.g., ACE, ACL, security attributes), auditing can be extended beyond simple content auditing to include processing this additional data. Metadata available in an example crawling system may include a URL, an ACL, a content type, a crawl depth, a language code, an attribute count, an attribute list, an owner GUID, a source hierarchy, and so on.

Auditing normalized data provided by a crawler at a post-crawl phase facilitates auditing with a single approach across an enterprise, rather than with a set of approaches having an approach for each data type, each data source, and so on. Additionally, auditing can be performed for non-transactional systems (e.g., file systems, websites).

One example enterprise search system into which auditing logic 220 can be integrated is SES. SES facilitates crawling data in many formats stored in many locations. SES can crawl (search) data in different formats (e.g., files, web pages, emails) stored in different locations (e.g., servers, desktops, repositories). The crawling can be scheduled to run periodically (e.g., hourly, daily). The crawling may build an index so that enterprise personnel (e.g., users) can do a search. Specific crawls can be directed to specific sources, specific locations, specific file types, files accessible by users with certain security privileges, and so on. The crawling examines and the index organizes data, metadata, and security information.

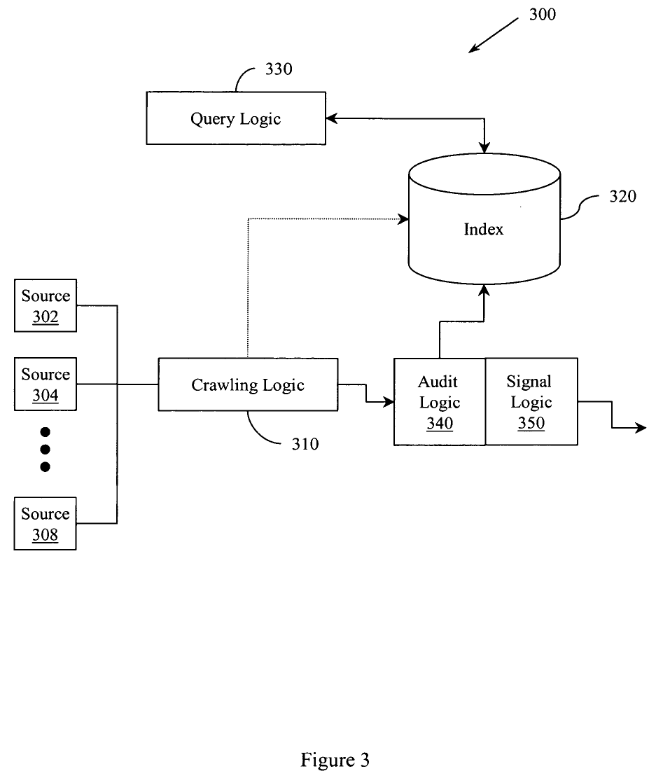

FIG. 3 illustrates an enterprise search system 300 in which post-crawl auditing may be performed. System 300 includes a crawling logic 310 and an audit logic 340 similar to those described in connection with FIG. 2. The crawling logic 310 may be configured to provide the crawl data to an index logic that uses the crawl data to maintain an index 320 that supports query processing for documents belonging to the enterprise. Query processing may be undertaken by a query logic 330. Rather than query logic 330 searching sources (e.g., source 302, source 304, . . . source 308) itself, query logic 330 may interact with index 320 to identify relevant documents whose contents may then be selectively retrieved. Query logic 330 and the index logic may operate independent of the presence or absence of audit logic 340 and signal logic 350.

System 300 also includes a signal logic 350 that is configured to provide a signal based, at least in part, on the state of a document whose crawl data is audited by audit logic 340. The signal provided may depend on a document's compliance with an audit standard as determined by applying an audit rule. Whether an audit rule is applied may depend on a dynamically configurable parameter related, for example, to a user input, a schedule, a volume of crawl data observed, and a type of crawl data observed. The audit standard may concern, for example, document location, document security, document modification, and document access.

Some portions of the detailed descriptions that follow are presented in terms of method descriptions and representations of operations on electrical and/or magnetic signals capable of being stored, transferred, combined, compared, and otherwise manipulated in hardware. These are used by those skilled in the art to convey the substance of their work to others. A method is here, and generally, conceived to be a sequence of operations that produce a result. The operations may include physical manipulations of physical quantities. The manipulations may produce a transitory physical change like that in an electromagnetic transmission signal.

It has proven convenient at times, principally for reasons of common usage, to refer to these electrical and/or magnetic signals as bits, values, elements, symbols, characters, terms, numbers, and so on. These and similar terms are associated with appropriate physical quantities and are merely convenient labels applied to these quantities. Unless specifically stated otherwise, it is appreciated that throughout the description, terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different points in time.

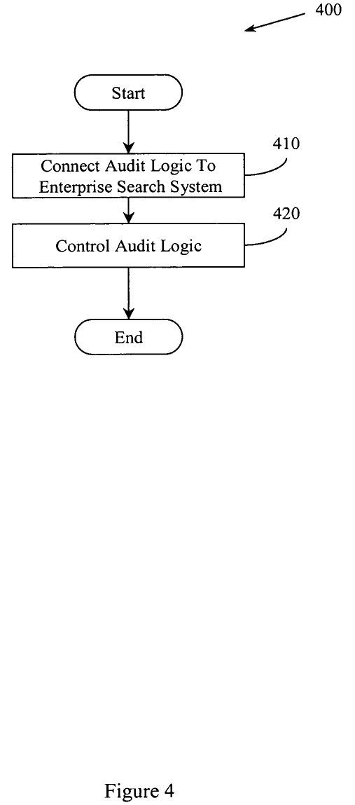

FIG. 4 illustrates a method 400 for reconfiguring an enterprise search system to perform post-crawl auditing. Method 400 may include, at 410, operably connecting an audit logic to an enterprise search system that includes a crawler logic and an index logic. The crawler logic may be configured to provide crawl data to the index logic. The index logic may be configured to maintain an index of documents belonging to an enterprise. The index may depend on the crawl data. For example, the index may store content, metadata, and security information for a document to facilitate determining which documents are relevant to a query without having to do on demand document searching. The enterprise search system may operate regardless of whether the audit logic is operably connected to the enterprise search system. In one example, the audit logic may be operably connected in a manner that facilitates receiving crawl data in parallel with delivery to the index logic.

Method 400 may also include, at 420, controlling the audit logic to audit a document belonging to the enterprise. Auditing a document may be performed by processing the crawl data. For example the audit logic may be controlled to select rules to apply by consulting a rules index using words from a query. The audit logic may also be controlled to apply a rule to the data and to generate a signal based on the results of the rule application.

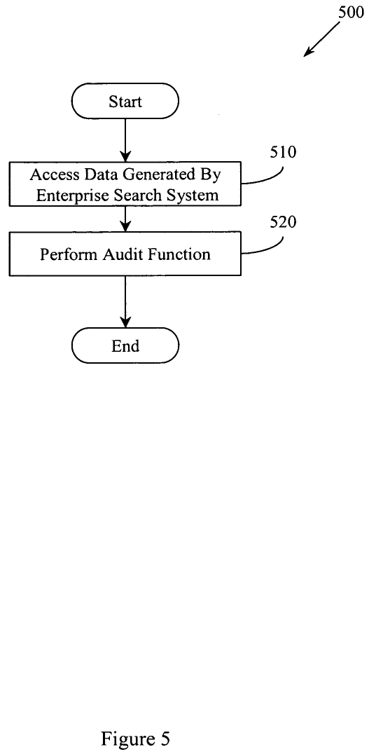

FIG. 5 illustrates a method 500 associated with post-crawl auditing. Method 500 may include, at 510, accessing data generated by an enterprise search system. The data may concern a document belonging to an enterprise. In one example, accessing the data may include accessing data generated by a crawler. The crawler may crawl different types of documents (e.g., email, calendar, presentation, website). These documents may be stored in different repositories (e.g., database, content management system, website) in an enterprise. The data provided by the crawler may be accessed independently of the data being provided to another element (e.g., index logic, index, query logic) in the enterprise search system.

Method 500 may also include, at 520, performing an audit function on the document belonging to the enterprise. Performing the audit function may include processing the data generated by the enterprise search system. It is to be appreciated that the audit function may be performed independent of delivering the data generated by the enterprise search system to a different recipient (e.g., index logic). In one example, performing the audit function may include comparing a modification date for a document to an audit standard concerning modification dates. Similarly, performing the audit function may include comparing an access date for a document to an audit standard concerning access dates. Performing the audit function may also include, for example, comparing an identity for a user who accessed a document to an identity audit standard, comparing a relocation event for a document to a relocation audit standard, and comparing a relocation destination for a document to a relocation destination audit standard.

While FIG. 5 illustrates various actions occurring in serial, it is to be appreciated that various actions illustrated in FIG. 5 could occur substantially in parallel. By way of illustration, a first process could access data generated by an enterprise search system and a second process could perform an audit function. While two processes are described, it is to be appreciated that a greater and/or lesser number of processes could be employed and that lightweight processes, regular processes, threads, and other approaches could be employed.

In one example, a method may be implemented as processor executable instructions. Thus, in one example, a machine-readable medium may store processor executable instructions that if executed by a machine (e.g., processor) cause the machine to perform a method that includes accessing data generated by a crawler in an enterprise search system and performing an audit function by processing the data generated by the crawler. While the above method is described being stored on a machine-readable medium, it is to be appreciated that other example methods described herein may also be stored on a machine-readable medium.

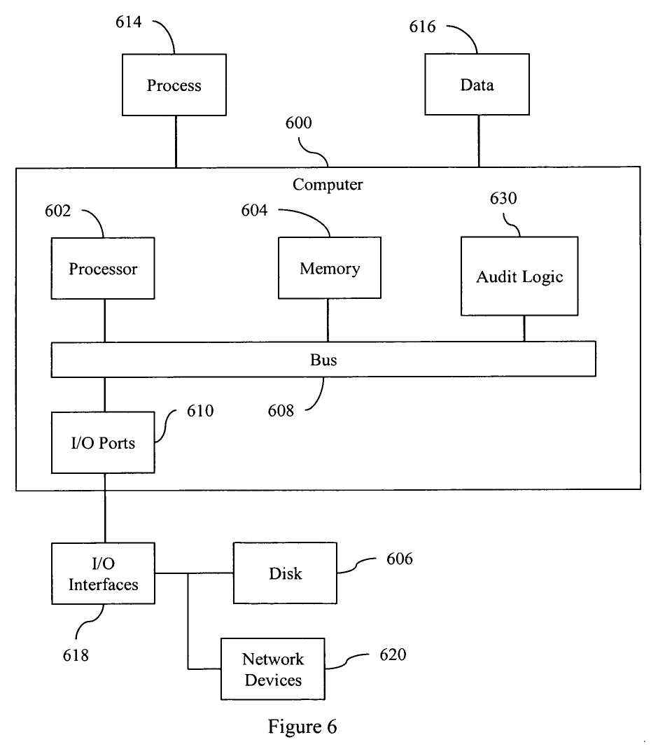

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include an audit logic 630 configured to facilitate post-crawl auditing. In different examples, the logic 630 may be implemented in hardware, software, firmware, and/or combinations thereof. Thus, the logic 630 may provide means (e.g., hardware, software, firmware) for accessing normalized data produced by an enterprise crawler that crawls documents having different types stored in different repositories throughout an enterprise. Logic 630 may also provide means (e.g., hardware, software, firmware) for maintaining an index that depends on the normalized data. Logic 630 may also provide means (e.g., hardware, software, firmware) for auditing a document in the enterprise by processing normalized data associated with the document. While the logic 630 is illustrated as a hardware component operably connected to the bus 608, it is to be appreciated that in one example, the logic 630 could be implemented in the processor 602.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, and/or a memory stick. Furthermore, the disk 606 may be a CD-ROM, a CD recordable drive (CD-R drive), a CD rewriteable drive (CD-RW drive), and/or a digital video ROM drive (DVD ROM). The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCIE, SATA, Infiniband, 1394, USB, Ethernet). The bus 608 can be types including, for example, a memory bus, a memory controller, a peripheral bus, an external bus, a crossbar switch, and/or a local bus.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a local area network (LAN), a wide area network (WAN), and other networks.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
an audit logic to apply an audit rule to a crawl data to determine a state of a document with respect to compliance with an audit standard,
where the crawl data is provided by a crawling logic configured to access a plurality of documents stored on a plurality of repositories, and where members of the plurality of documents may have different document types; and
a signal logic to provide a signal based, at least in part, on the state of the document with respect to compliance with the audit standard.

2. The system of claim 1, the audit logic being configured to selectively apply an audit rule based, at least in part, on a dynamically configurable parameter.

3. The system of claim 2, the dynamically configurable parameter being related to one or more of, a user input, a schedule, a volume of crawl data observed, and a type of crawl data observed.

4. The system of claim 1, the audit logic being configured to receive crawl data that includes a normalized set of data that includes one or more members relevant to a plurality of document types.

5. The system of claim 1, the audit logic being configured to receive crawl data that includes document content.

6. The system of claim 5, the audit logic being configured to receive crawl data that includes metadata concerning a document.

7. The system of claim 6, the audit logic being configured to receive metadata that includes one or more of, a document modification time, a globally unique identifier (GUID) that identifies a modifier of a document, a document URL (Uniform Resource Locator), and a data source associated with a document.

8. The system of claim 6, the audit logic being configured to receive crawl data that includes security data.

9. The system of claim 8, the audit logic being configured to receive security data that includes one or more of, an access control entry (ACE), an access control list (ACL), and a security attribute.

10. The system of claim 1, where the audit standard concerns one or more of, document location, document security, document modification, document, repository, and document access.

11. The system of claim 1, including a rules index that stores information concerning one or more audit rules.

12. The system of claim 1, including the crawling logic, where the crawling logic can operate independent of the presence of the audit logic.

13. The system of claim 12, including an index logic to operate independent of the presence of the audit logic, the index logic to use crawl data to maintain an index that supports query processing for documents, the audit logic to operate independent of the index logic.

14. The system of claim 13, including a query logic that can operate independent of the presence of the audit logic, the query logic being configured to provide a query to the index logic, the index logic being configured to identify one or more documents relevant to the query.

15. A system, comprising:
a crawling logic to provide a crawl data, the crawling logic to access a plurality of documents stored on a plurality of repositories, where members of the plurality of documents may have different document types, where the crawl data includes a normalized set of data that includes one or more members relevant to a plurality of document types, the normalized set of data including document content, metadata concerning a document, and security data concerning a document;
an index logic to use the crawl data to maintain an index that supports query processing for documents belonging to the enterprise;
a query logic to provide a query to the index logic, the index logic being configured to identify one or more documents relevant to the query;
an audit logic to apply an audit rule to the crawl data to determine a state of a document with respect to compliance with an audit standard, the audit logic being configured to selectively apply an audit rule based, at least in part, on a dynamically configurable parameter related to one or more of, a user input, a schedule, a volume of crawl data observed, and a type of crawl data observed,
a rules index to store information concerning one or more audit rules; and
a signal logic to provide a signal based, at least in part, on the state of the document with respect to compliance with the audit standard,
the crawling logic, the index logic, and the query logic being configured to operate independent of the presence of each other.

16. A method, comprising:
operably connecting an audit logic to an enterprise search system that includes a crawler logic and an index logic, the crawler logic being configured to provide a crawl data to the index logic, the index logic being configured to maintain an index of documents belonging to an enterprise based, at least in part, on the crawl data; and
controlling the audit logic to audit a document belonging to the enterprise by processing the crawl data without altering the operation of the crawler logic and without altering the operation of the index logic.

17. The method of claim 16, where controlling the audit logic to audit a document includes controlling the audit logic to apply an audit rule to the crawl data.

18. A method, comprising:
accessing a data generated by an enterprise search system, where the data concerns a document belonging to an enterprise; and
performing an audit function on the document belonging to the enterprise by processing the data generated by the enterprise search system, where performing the audit function is performed independent of delivery to a recipient of the data generated by the enterprise search system.

19. The method of claim 18, where accessing the data generated by the enterprise search system includes accessing data generated by a crawler that is configured to crawl a plurality of types of documents that may be stored in a plurality of repositories within the enterprise.

20. The method of claim 19, where performing the audit function includes one or more of, comparing a modification date for a document to an audit standard concerning modification dates, and comparing an access time for a document to an audit standard concerning access times.

21. The method of claim 20, where performing the audit function includes one or more of, comparing an identity for a user who accessed a document to an audit standard concerning document access, comparing a relocation event for a document to an audit relocation standard, and comparing a relocation destination for a document to the audit relocation standard.

22. The method of claim 19, where performing the audit function includes applying a rule to the data generated by the enterprise search system.

23. The method of claim 22, where applying a rule to the data generated by the enterprise search system includes selecting a rule from a rules index, where a term in the data generated by the enterprise search system indexes into the rules index.

24. The method of claim 18, including controlling the enterprise search system to perform an additional search based, at least in part, on the results of performing the audit function on the document belonging to the enterprise.

25. A machine-readable medium having stored thereon machine-executable instructions that if executed by a machine cause the machine to perform a method, the method comprising:
accessing a data generated by a crawler that is configured to crawl a plurality of types of documents that may be stored in a plurality of repositories within an enterprise, where the data concerns a document belonging to the enterprise; and
performing an audit function on the document belonging to the enterprise by processing the data generated by the crawler, where performing the audit function is performed independent of delivery to a recipient of the data generated by the crawler, and where performing the audit function includes one or more of, comparing a modification date for a document to an audit standard concerning modification dates, comparing an access time for a document to an audit standard concerning access times, comparing an identity for a user who accessed a document to an audit standard concerning document access, comparing a relocation event for a document to an audit relocation standard, and comparing a relocation destination for a document to the audit relocation standard,
where performing the audit function includes applying a rule to the data generated by the crawler, and where applying a rule to the data generated by the crawler includes selecting a rule from a rules index, where a term in the data generated by the crawler indexes into the rules index.

26. A system, comprising:
means for accessing normalized data produced by an enterprise crawler configured to crawl a plurality of document types stored in a plurality of locations within an enterprise;
means for maintaining an index of documents belonging to the enterprise, where the maintaining depends on the normalized data; and
means for auditing a document in the enterprise by processing the normalized data, where auditing the document does not interfere with maintaining the index of documents.
